(19) United States
(12) Patent Application Publication
(10) Pub. No.: US 2021/0145214 A1
(43) Pub. Date: May 20, 2021

(54) MODULAR HEATED FOOD-SERVICE DISPLAY

(71) Applicant: Brass Smith Innovation, LLC (BSI, LLC), Wilmington, DE (US)

(72) Inventors: Geoffrey R. Quinter, Wilmington, DE (US); Wayne Sirmons, Wilmington, DE (US)

(21) Appl. No.: 16/685,890

(22) Filed: Nov. 15, 2019

(51) Int. Cl. A47J 39/02; A47F 10/02; A47F 10/06; A47F 3/00; A47F 5/10

(52) U.S. Cl. CPC A47J 39/02; A47F 10/02; A47F 5/108; A47F 3/001; A47F 10/06

(57) ABSTRACT

A modular heated display system with at least one heated display unit and at least one frame extension. The heated display unit will typically include a heating element supported by a frame. When the heated display unit is set upon a supporting surface, the heating element is raised some distance above the supporting surface by the frame. One or more frame extensions may be removably coupled to the frame opposite the heating element. Any coupled frame extension serves to elevate the heating element to a different height above the supporting surface. In some implementations, the heated display unit will include a light source within the frame, generally position underneath the heating element. Control electronics may be provided to cause the light source to project light downward, onto the supporting surface below the frame when the heating element is active or at an elevated temperature.

### FIELD OF THE INVENTION

The present disclosure relates to systems, apparatus and methods for implementing a heated food-service display, and more particularly to systems, apparatus and for implementing a modular heated display system having one or more heating units with user adjustable height and downwardly directed illumination.

### BACKGROUND OF THE INVENTION

Many institutions such as restaurants, schools, cafeterias, grocery stores, hospitals, and the like display prepared foods for attended service or self-service to customers. Many foods are served cold or at room temperature and can easily be arranged and displayed in salad bars, under food shields, along serving lines or from other cafeteria-style food service apparatus. With other foods however, it is advantageous to heat the food as it is displayed, to maintain an appetizing and safe temperature before service.

Certain food service implementations therefore include relatively large built-in steam trays and similar apparatus is to keep a large quantities of food warm for service. Some types of food; soups, sauces, and stews for example, are not well suited for display and service from a large but shallow built-in steam trays. These foods our often displayed and served from a hot plate having a heating element positioned underneath a pot, pan or other food storage container. Conventional hot plates can be relatively unattractive, and very difficult to arrange in creative and visually appealing arrays. The embodiments disclosed herein are directed toward overcoming one or more of the above problems.

### SUMMARY

Various embodiments disclosed herein provide improved apparatus and methods for implementing a heated display unit or an array of heated display units in a heated display system. One representative system is a modular heated display system with at least one heated display unit and at least one frame extension. System embodiments may include any number of heated display units and frame extensions which may be mixed, matched, stacked and otherwise implement as described herein.

A heated display unit will typically include a heating element supported by a frame. When the heated display unit is set upon a supporting surface, the heating element is raised some distance above the supporting surface by the frame. In a system embodiment, one or more frame extensions having any selected height may be removably coupled to the frame opposite the heating element. Any coupled frame extension serves to elevate the heating element to a different height above the supporting surface. In some embodiments, the frame extension(s) may be removably coupled and uncoupled from the heated display unit frame without the use of tools.

In certain embodiments, a heated display unit will include a light source within the frame, generally position underneath the heating element. Control electronics may be provided to cause the light source to project light downward, onto the supporting surface below the frame when the heating element is active or at an elevated temperature. Any embodiment of heated display unit, lighted or otherwise, may include a safety grid attached to the frame to prevent unauthorized access to internal components. Embodiments with a safety grid and a light source can utilize openings formed in the safety grid to create a shaped illumination pattern in the light projected from the light source to the supporting surface. In any lighted embodiment, the heated display unit may include a frame sidewall preventing direct observation of the light source when the unit is placed upon the supporting surface, plus an opening in either the frame sidewall or a frame extension sidewall permitting viewing of the light or the shaped illumination pattern projected on the supporting surface.

Alternative embodiments include stand-alone heated display units, without an ancillary frame extension, having lighting systems as described above. Other alternative embodiments include methods of providing, organizing, arranging, and lighting a system or array of heated display units and frame extensions.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

FIG. 1 is a perspective view of a heated display unit on a supporting surface.

FIG. 2 is a perspective view of a heated display unit coupled to a frame extension on a supporting surface.

FIG. 3 is partially exploded view of the heated display unit and frame extension of FIG. 2.

FIG. 4 is a perspective view of a heated display unit coupled to a frame extension having a sidewall height less than the sidewall height of the frame extension of FIG. 2.

FIG. 5 is a partially exploded view of the heated display unit and frame extension of FIG. 4.

FIG. 6 is an underside perspective view of a heated display unit.

FIG. 7 is an exploded view of the heated display unit of FIG. 6.

FIG. 8 is an exploded view of selected frame, insulation and lighting elements of the heated display unit of FIG. 6.

FIG. 9 is an underside perspective view of selected frame, insulation and lighting elements of the heated display unit of FIG. 6.

FIG. 10 is a perspective view of selected safety grid and electronic control elements of a heated display unit.

FIG. 11 is an exploded view of the safety grid and, electronic control elements of FIG. 10.

### DETAILED DESCRIPTION OF THE INVENTION

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The embodiments disclosed herein include modular heated display units 10 that may be used to display and heat food contained in a pot, pan, serving dish, tray, casserole, or similar container. The disclosed embodiments are therefore well-suited to displaying and heating food at a buffet, self-serve restaurant, cafeteria or other commercial or residential location where food is displayed and served. Although the disclosed heated display units 10 are particularly well-suited to display and warm previously prepared food during food service, the heated display units 10 could be used to cook food.

As detailed below, the modular heated display units 10 disclosed herein have components that may be mixed and matched together to easily, attractively and functionally vary the functional height of individual units. In addition, certain embodiments disclosed herein include functional down lighting to enhance the safety of the heated display units 10 and further enhance the attractiveness of same.

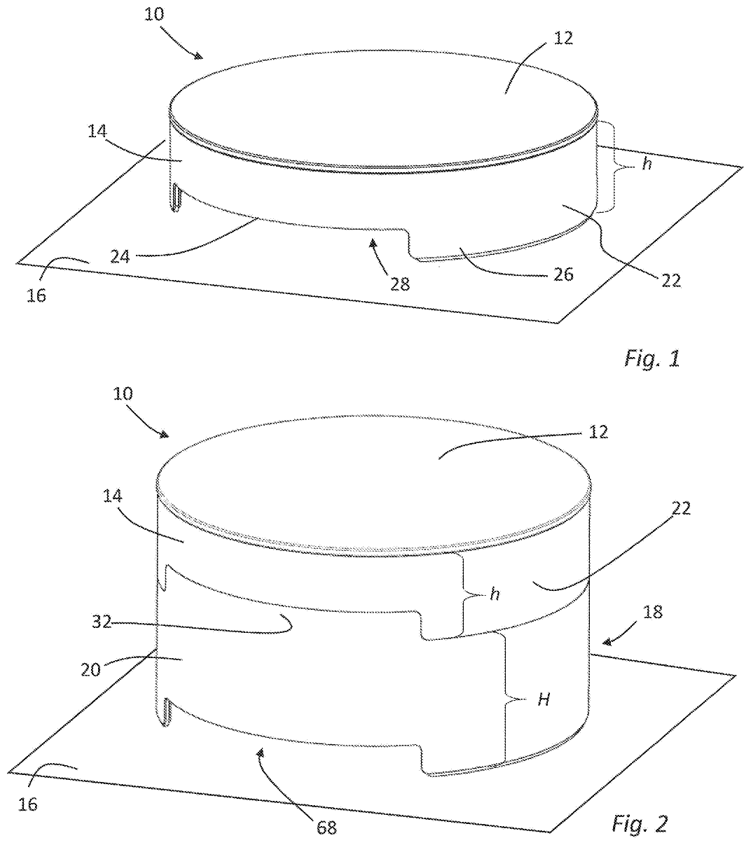

FIG. 1 is a perspective view of an individual heated display unit 10. The heated display unit 10 includes a heating element 12 supported by a frame 14. In the illustrated embodiments, the heating element 12 includes resistive heating coils embedded in a high-temperature glass, ceramic, metal, thermoplastic or similar matrix. Alternative heating surfaces or heating elements may include exposed or partially exposed resistive heating coils, enclosed or exposed gas burners, induction hobs or other cook top technologies. In many implementations, the heated display unit 10 will have a heating element 12 providing maximum thermal output at a level sufficient to maintain a desired service temperature for previously cooked food items. Alternative embodiments may have greater maximum thermal output, as would be necessary to perform conventional cooking tasks, as well as maintaining the temperature of previously cooked food.

As illustrated in FIG. 1, the frame 14 serves to support and elevate the heating element 12 above a supporting surface 16. The supporting surface 16 may be any sort of counter, buffet, bar, table, sideboard, shelf, or other structure upon which food is displayed or served. The illustrated heated display unit 10 is circular when viewed from above and sized to fit under a conventional pot or dish. The heated display unit 10 may have any desired shape including but not limited to circular, square, or polygonal shapes when viewed from the top. Similarly, the heated display unit 10 may be fabricated in any desired size, although the heated display unit 10 will typically be sized to be easily carried and arranged by a user.

As illustrated in FIGS. 2-5, the frame 14 of a heated display unit 10 may optionally be coupled to and supported by one or more frame extensions 18. A frame extension 18 serves to elevate the frame 14 and corresponding heating element 12 of a heated display unit 10 to a greater height above the supporting surface 16 than the height at which the heating element 12 would be positioned if no frame extension were used.

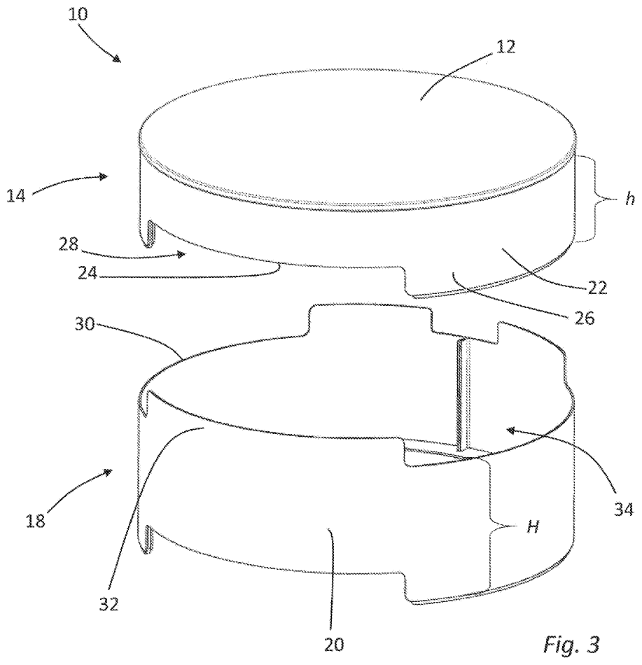

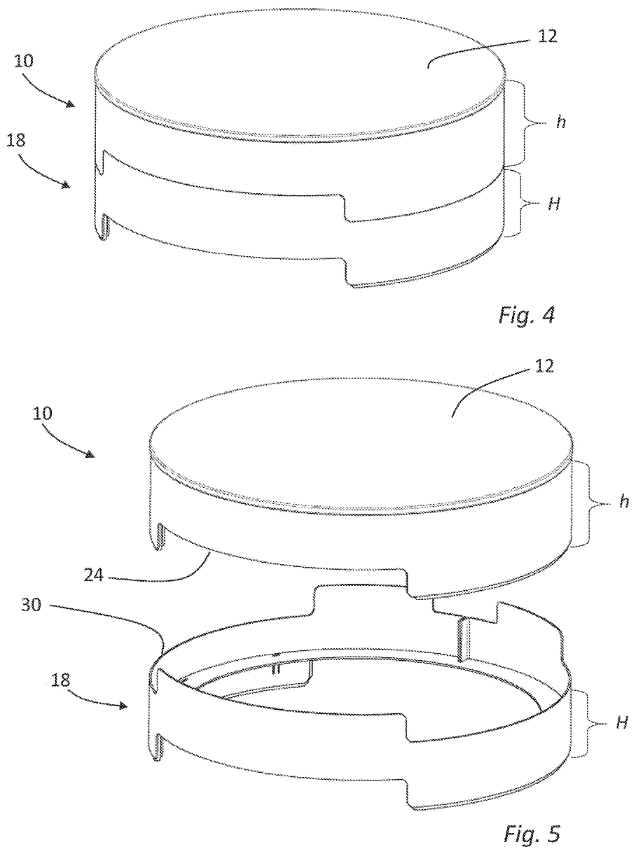

The frame extensions 18 of FIGS. 2-5 include a frame extension sidewall 20 with a height “H”. In the FIG. 2 and FIG. 3 embodiment the frame 14 includes a frame sidewall 22 having a corresponding height “h” that is lesser than the frame extension sidewall height H. A system may include any number of frame extensions 18 having greater or lesser heights H. For example, as illustrated in FIG. 4 and FIG. 5, a heated display unit 10 may be coupled to an alternative frame extension 18 having a lesser height H. In certain embodiments, a single heated display unit 10 may be coupled to multiple frame extensions 14 having the same or different heights. Thus, multiple heated display units 10 may be coupled to various combinations of frame extensions 18, or in some cases used without a frame extension 18, to create an attractive and highly functional array of heated display units 10 with differing heating element 12 heights.

One method of coupling a heated display unit 10 to a frame extension 18 is shown in FIGS. 2-5. In this embodiment, a heated display unit 10 may include a frame sidewall 22 defining a lower edge 24 that is structured into legs 26 and recesses 28 around the perimeter of the lower edge 24. The mating frame extensions 18 includes a sidewall 20 having an upper edge 30 formed into corresponding upward pointing legs 32 and recesses 34. When a heated display unit 10 is mated to a frame extension 18, the upward pointing legs 32 of the frame extension couple closely to corresponding recesses 28 in the frame sidewall 22. Similarly, upward pointing recesses 34 of the frame extension sidewall 20 couple closely to corresponding legs 26 formed to extend down from the frame sidewall 22.

The structures of the lower edge 24 of the frame 14 and the upper edge 30 of the frame extension 18 are not limited to the structure shown in the figures. Any number of shapes, contours, extensions or recesses may be formed in or near the corresponding lower and upper edges of the frame 14 and frame extension 18 respectively. For example, the corresponding frame and frame extension edges 24, 30 may be formed into mating sine wave patterns, mating sawtooth patterns, mating square wave patterns, mating irregular patterns and the like. In each case, the edges 24 and 30 will, in part, extend above or below an imaginary plane through the edge 24, 30, which plane is parallel to a plane defined by the heating element 12. Thus, in this disclosure, a structured edge 24, 30 is defined as a “non-planar” edge.

Additional security may be added to the coupling between the non-planar upper edge of the frame extension 30 and the non-planar lower edge of the frame 24 by providing supplemental structures that serve to prevent lateral movement between the mated edges. For example, one or both edges could be provided with tongue and groove structures, teeth of greater or lesser depth, pins and sockets, or similar elements. In the illustrated embodiment a safety grid leg 40 (described in detail below) extends across the inside of the joint between the lower frame edge 24 and upper frame extension edge 30 to prevent lateral movement at the frame and frame extension edges 24, 30 to provide additional security.

In certain embodiments, the weight of the heated display unit 10 and the non-planar shape of the mated lower frame edge 24 and upper frame extension edge 30 are sufficient to securely couple a heated display unit 10 to a frame extension 18 during use. As noted above, a supplemental structure, for example a safety grid leg 40 may extend across the joint between the edges 24 and 30 to provide additional security. In these embodiments, a heated display unit 10 may be quickly attached to one or multiple frame extensions 18 having desired heights, without the use of tools. Entire arrays of heated display units 10 and frame extensions 18 may be quickly assembled or disassembled such that the heating elements 12 are located at selected heights. In other embodiments, the connection between a heated display unit 10 and frame extension 18 may be secured with a screw, tape, adhesive or another fastener.

FIG. 5 is a perspective view of the underside of a heated display unit 10. Elements of the heated display unit 10 operatively positioned below the heating element 12 are protected from tampering and unauthorized access from underneath by a safety grid 42 attached to the frame 14. In certain embodiments, a power cable 46 extends through the safety grid 42. The power cable 46 may be attached to a conventional or custom power outlet to provide electrical power to the heating element 12. The power cable 46 will, in certain embodiments, terminate within or on the heated display unit 10 in an electronic heating element control module 48. The electronic heating element control module 48 may include a user control knob 49 or other switch accessible from outside of the frame 14 to provide for user control over the thermal output of the heating element 12. The electronic control module 48 may be implemented with a simple resistive control element, or with a more sophisticated electronic control circuit including but not limited to a pulse width modulation circuit, a digital logic temperature control circuit, and the like. The heating element control module 48 may support specific temperature set points or may be implemented with an analog range of outputs ranging from off to full power. The heating element control module 48 may include an output display or other status indicator.

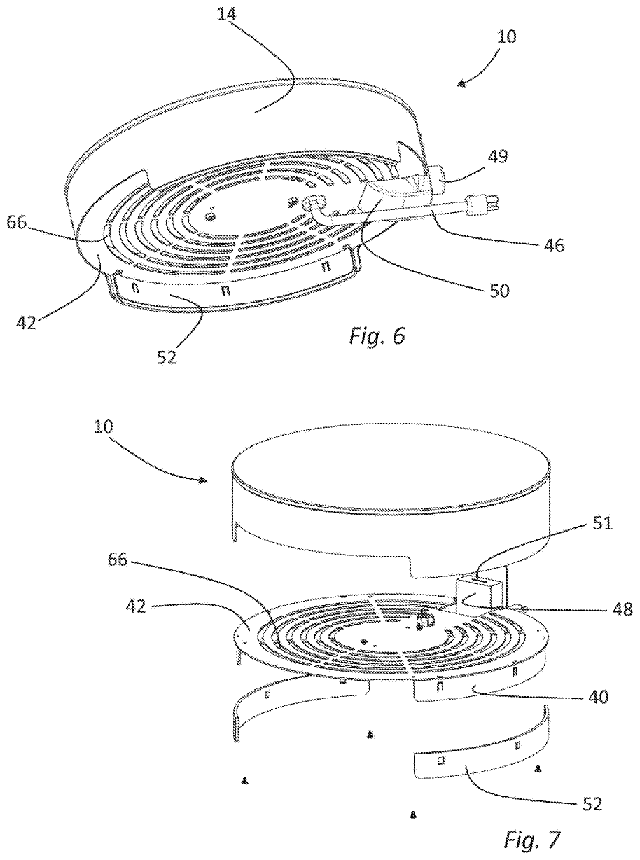

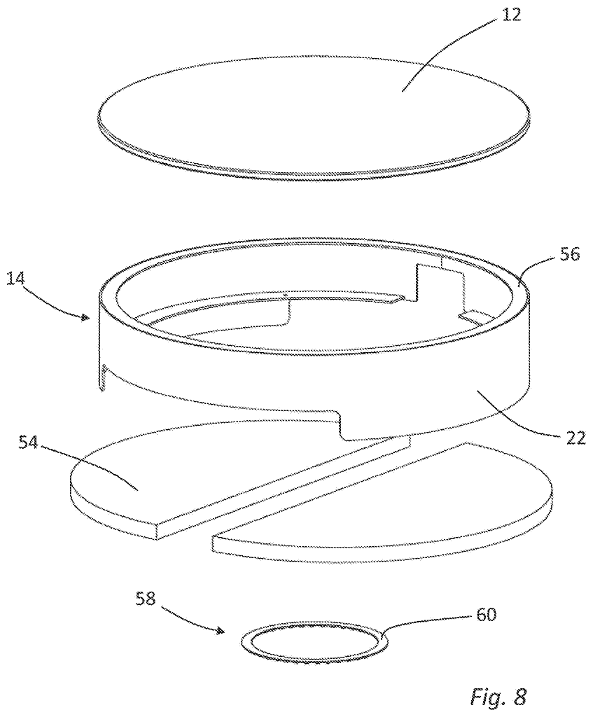

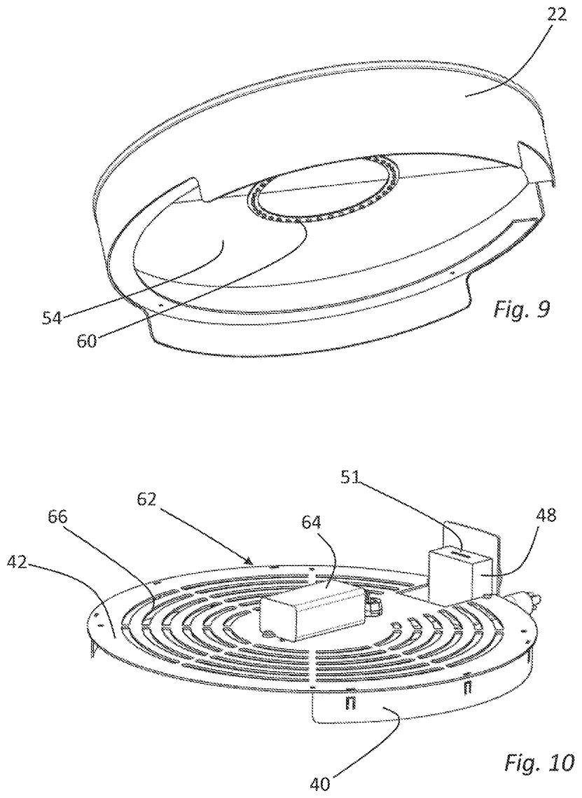

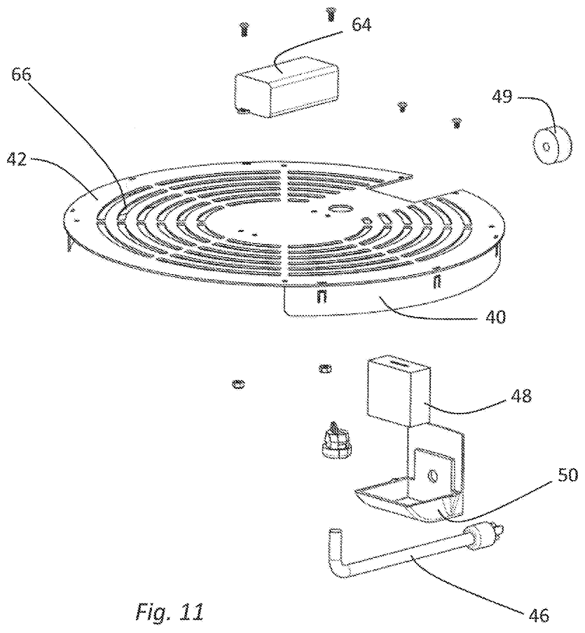

In some embodiments, as shown in FIG. 6 and FIG. 9, the heating element control module 48 may be supported by a control module housing 50 and electronically coupled to the heating element 12 at socket 50, providing for relatively easy device servicing. In other embodiments, the electronic control module may be directly wired to a heating element 12.

As noted above, the safety grid 42 may include safety grid legs 40, which in use extend short distance across the junction between the lower frame edge 24 and upper frame extension edge 30 to help secure the coupling between the frame 14 and any desired frame extension 18. As shown in FIG. 6, some embodiments may include supplemental safety grid leg extensions 52 which mount to the external or internal surfaces of selected safety grid legs 40 providing additional reinforcement.

As best shown in FIG. 7, the underside of the heating element 12 may be separated from other elements of the heated display unit 10 with insulation 54. In the specific embodiment illustrated in FIG. 7, the electronic heating element 12 may be attached to an upper rim 56 formed in the frame 14 using a high-temperature silicone adhesive, or other suitable method. In this embodiment, the insulation 54 is implemented as a layer of insulation half-circles that may be bonded, for example with high-temperature silicone adhesives, to the bottom surface of the heating element 12.

Certain embodiments of heated display unit 10 will include a light source 58 operatively associated with the underside of the heating element 12. The light source 58 may be illuminated when the heating element 12 is active, or when the heating element 12 is at an elevated temperature. Thus, the light source 58 may provide user safety by alerting a user that the heating element 12 may be too hot to safely touch. Also, as described in detail below, the light source 58 may enhance the overall appearance of an array including one or more heated display units 10.

In one embodiment, the light source 58 is implemented with a ring of downward facing light emitting diodes 60 (LEDs 60) attached to a bottom surface of the insulation 54. Other embodiments may include light sources 58 implemented with incandescent lightbulbs, electroluminescent panels, fluorescent lights or the like. Typically, any light source 58 will be connected electronically to a lighting driver and control circuit 62. For example, as shown in FIGS. 9 and 10, the ring of LEDs 60 may electronically communicate with an LED control transformer 64 mounted on an upper surface of the safety grid 42.

In the illustrated embodiment, the ring of LEDs 60 is positioned to project light downward from beneath the heating element 12 and insulation 54 assembly toward the supporting surface 16 upon which the heated display unit 10 is positioned. In the illustrated embodiment, the safety grid 42 is therefore positioned between the LEDs 60 and the supporting surface 16.

As shown in FIGS. 5, 6, 9, and 10, the safety grid 42 includes an array of openings 66 which are narrow enough to prevent a unauthorized personnel from reaching into the interior of the heated display unit 10, but wide enough to provide for ventilation. The safety grid openings also serve to form a shaped illumination pattern in the light projected from the light source 58 to the supporting surface 16. For example, in the illustrated embodiment the shaped illumination pattern will be an array of concentrically positioned arcs projected onto the supporting surface underneath the heated display unit 10, which visually suggest a conventional electric stovetop heating element. Thus, the shaped illumination pattern provides a visual warning to a user that the heating element 12 is active and/or hot.

The safety grid 42 may have openings providing a shaped illumination pattern having any decorative or functional configuration desired. Alternative shaped illumination patterns formed by openings 66 formed in the safety grid 42 include but are not limited to images, patterns, words, advertisements, symbols and the like. The lighting control electronics 62 and light source 58 may be configured to project light in one or multiple colors. Some light sources 58, for example the ring of LEDs 60 may be controlled to project time-varying colors and/or lighting intensities.

In some embodiments, the lighting control electronics 62 are electronically coupled to and except user input through or parallel with the heating element control module 48. This coupling may be relatively simple, for example, the heating element control module 48 may supply power to the lighting control electronics 60 when power is provided to the heating element 12. Alternatively, the lighting intensity, color, or another lighting parameter may vary as the desired heating output level is adjusted by a user with the heating control module 48.

In the illustrated embodiments, the frame side wall 22 substantially prevents direct viewing of the light source 58 by a user. On the contrary, the recesses 28 between the frame legs 26 allow a user to easily view the shaped illumination pattern projected onto the supporting surface 16. If the heated display unit 10 is coupled to one or more frame extensions 18, each frame extension may also include lower frame extension recesses 68 which permit a user to view the shaped illumination pattern on the supporting surface 16.

Having described certain exemplary embodiments, it will be understood by those skilled in the art that many changes in construction and widely differing embodiments and applications of the invention will suggest themselves without departing from the scope of the present invention.

Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A modular heated display system comprising:
a heating element;
a frame configured to support the heating element; and
a frame extension removably coupled to the frame opposite the heating element, wherein the frame extension is configured to elevate the frame and the heating element above a supporting surface.

2. The modular heated display system of claim 1 further comprising;
a non-planar lower frame edge terminating the frame opposite the heating element; and
a non-planar upper frame extension edge terminating the frame extension, wherein the non-planar upper frame extension edge is shaped to mate with the non-planar lower frame edge when the frame extension is coupled to the frame.

3. The modular heated display system of claim 2 wherein at least one of the frame or the frame extension comprises a supplemental structure preventing lateral movement at a point of contact between the lower frame edge and the upper frame extension edge.

4. The modular heated display system of claim 1 wherein the frame extension may be removably coupled and uncoupled from the frame without the use of tools.

5. The modular heated display system of claim 1 further comprising a supplemental frame extension configured to be removably coupled to the frame or to the frame extension, wherein the supplemental frame extension has a sidewall height less than a sidewall height of the frame extension.

6. The modular heated display system of claim 5 further comprising:
a light source operatively associated with an underside of the heating element; and
control electronics configured to cause the light source to project light to the supporting surface below the frame when the heating element is active.

7. The modular heated display system of claim 6 wherein the control electronics are further configured to cause the light source to project light to the supporting surface below the frame when the heating element is inactive, but at a temperature above an ambient temperature.

8. The modular heated display system of claim 6 further comprising a safety grid attached to the frame below the light source.

9. The modular heated display system of claim 8 further comprising safety grid openings in the safety grid configured to form a shaped illumination pattern in the light projected from the light source to the supporting surface.

10. The modular heated display system of claim 6 further comprising:
a frame sidewall preventing direct observation of the light source when the modular heated display system is placed upon the supporting surface; and
an opening in at least one of the frame sidewall or a frame extension sidewall permitting viewing of the light projected from the light source on the supporting surface.

11. A heated display comprising:
a heating element;
a frame configured to support the heating element at a selected height above a supporting surface;
a light source operatively associated with an underside of the heating element; and
control electronics configured to cause the light source to project light to the supporting surface below the frame when the heating element is active.

12. The heated display of claim 11 wherein the control electronics are further configured to cause the light source to project light to the supporting surface below the frame when the heating element is inactive, but at a temperature above an ambient temperature.

13. The heated display of claim 11 further comprising a safety grid attached to the frame below the light source.

14. The heated display of claim 13 further comprising safety grid openings in the safety grid configured to form a shaped illumination pattern in the light projected from the light source to the supporting surface.

15. The heated display of claim 11 further comprising:
a frame sidewall preventing direct observation of the light source when the heated display is placed upon the supporting surface; and
an opening in the frame sidewall permitting the shaped illumination pattern to be viewed on the supporting surface.

16. A method of implementing a heated display system comprising:
providing a heated display unit comprising a heating element and a frame, said frame comprising a non-planar lower frame edge opposite the heating element;
coupling the frame to a frame extension having a non-planar upper frame extension edge, wherein the non-planar upper frame extension edge is mated with the non-planar lower frame edge; and
placing the coupled heated display unit and frame extension onto a supporting surface, to elevate the heating element to a first height above the supporting surface.

17. The method of claim 16 further comprising:
elevating the heating element to a second height above the supporting surface by coupling the frame to a supplemental frame extension having a side wall height less than a sidewall height of the frame extension.

18. The method of claim 16 further comprising:
operatively associating a light source with an underside of the heating element;
providing control electronics configured to control the light source; and
controlling the light source to project light to the supporting surface below the frame when the heating element is active.

19. The method of claim 18 further comprising:
attaching a safety grid to the frame below the light source;
forming a shaped illumination pattern in the light projected from the light source to the supporting surface with the safety grid.

20. The method of claim 18 further comprising:
preventing direct observation of the light source with a frame sidewall when the heated display system is placed upon the supporting surface; and
providing an opening in at least one of the frame sidewall and a frame extension sidewall permitting the light projected below the frame to be viewed on the supporting surface.
